(19) United States
(12) Patent Application Publication
(10) Pub. No.: US 2007/0203769 A1
(43) Pub. Date: Aug. 30, 2007

(54) Method of selecting and matching professionals

(76) Inventor: Tracey R. Thomas, Boonton, NJ (US)

Correspondence Address: LAW OFFICES OF ALOZIE N. ETUFUGH, PLLC, SUITE 4D, 30 CENTRAL PARK SOUTH, NEW YORK, NY, 10019, US

(21) Appl. No.: 11/715,991

(22) Filed: Mar. 9, 2007

Related U.S. Application Data
(63) Continuation-in-part of application No. 11/250,843, filed on Oct. 14, 2005.

(51) Int. Cl. G06F 9/44; G06F 17/50; G06N 5/02; G08B 23/00

(52) U.S. Cl. 705/7; 706/48; 340/573.1

(57) ABSTRACT

A method of selecting desired repairs persons in a system by a user, which includes the process of forming a collective of repair persons on a system and allows users to sign on to the system. Once signed on to the system, users are able to search for matching repair persons based on search criteria provided by the users. With a match, the repair persons and users are notified and they proceed to schedule the project.

### CROSS REFERENCE TO RELATED APPLICATIONS

This application is a Continuation-In-Part (CIP) application to utility application Ser. No. 11/250,843 entitled, “A Method of Selecting And Matching Professionals” filed Oct. 14, 2005 by Tracey R. Thomas.

### TECHNICAL FIELD OF THE INVENTION

The present invention relates generally to the selection and matching professionals in a field. More specifically, the selection and matching of professionals in order to meet certain customer demands or criteria.

### BACKGROUND OF THE INVENTION

Real estate investors and homeowners alike have difficulty finding reliable home repair persons. While lists of home repair individuals and companies are available on various websites, these lists or websites fail to be useful to real estate investors or homeowners as there is no objective rating system for the listed repair persons/companies. In addition, there is no easy way to determine whether the listed repair persons'/companies' pricing presents a competitive or desired value. Furthermore, none of these sites provides information pertaining to bonding (insurance), experience, or any other criteria deemed relevant by real estate investors or homeowners. An investor or homeowner seeking to undertake a repair project would like to find or be matched with the right repair person for the right price while meeting some other criteria as defined by the investor or homeowner.

As such, there is a need for a comprehensive and interactive system that allows for the efficient matching of homeowners with repair persons by virtue of certain criteria such as experience, bonding, ratings, reviews, cost, etc.

### SUMMARY OF THE INVENTION

Accordingly, it is an advantage of the present invention to provide a method of matching real estate investors or homeowners with the contractor(s)/repair person(s) of their choice by virtue of certain criteria defined by the real estate investor or homeowner.

Another advantage of the present invention is that repair persons are rewarded for the quantity, quality of service and other factors as rated by the system in accordance with the invention.

An additional advantage of the present invention is that the site owner or administrator negotiates a group or individual discounts for repair persons that offer services on the site.

An additional advantage of the present invention is that users are rewarded (in a rewards system) for the frequency of their use of the system service and other factors as rated by the system in accordance with the invention.

An additional advantage of the present invention is where the rewards system is an automated cash rebate system, discount system, or points-based system where the points can be used like cash to purchase awards, get discounts on services or parts and materials on the system site or at other merchant locations and websites.

An additional advantage of the present invention is that real estate investors or homeowners can be referred to another site or service should there be no match in the system.

An additional advantage of the present invention is the ability for real estate investors, homeowners and repair persons to signup for the service in one integrated database thereby allowing for tracking, discounts eligibility, recording etc.

A further advantage of the present invention is that repair persons are encouraged to provide quality service in a timely fashion by virtue of an awards system.

An even further advantage of the present invention is the implementation of a method for matching real estate investors or homeowners with the repair person(s) of their choice by way of integrated internet-based systems, local database systems, and phone-in systems or the like etc.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a flow chart showing the process undertaken by a customer (e.g. a real estate investor or a homeowner) signing on to the system in accordance with the invention.

FIG. 2 is a flow chart showing the process undertaken by an interested customer with, inter alia, a check for membership and opportunity to sign up as a member of the system in accordance with the invention.

FIG. 3 is a flow chart showing the matching process and options for the customer should there be no match.

FIG. 4 is a flow chart showing the process undertaken by a customer in accordance with the invention where the customer is provided with recommendations if no match is made.

FIGS. 5-8 are flow charts showing repair persons' interaction with the system in accordance with the invention.

FIG. 9 is a flow chart showing the implementation of an awards program in accordance with the invention.

### DESCRIPTION OF THE PREFERRED EMBODIMENT(S)

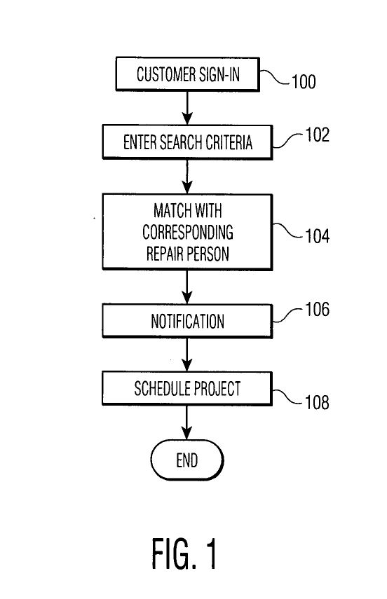

FIG. 1 shows a customer's interaction with the system in accordance with the invention. In step 100, the customer signs on to the system. Such signing on may include providing a phone number, password, fingerprint reading or the like, etc. In a preferred embodiment, the signing on process would be free and would not require detailed background information on the customer's part. After the customer has signed on, he or she is then required to enter certain search criteria in step 102. Search criteria may be anything that pertains to the work the customer needs to be done, the repair person's insurance levels, insurance coverage regarding the repairs and other information regarding insurance coverage, repair person's bonding levels, repair person's level of experience, repair person's rating, etc., where the rating can be provided by the site or based on user ratings. In an alternate embodiment, the search criteria may include setting the price the customer is willing to pay for the project. In doing so, the customer will fill out a form describing work to be done. Next, the customer will provide his/her payment means for the project—be it by credit card, cash, check or some other payment means. This will guarantee payment for the project upon completion. The customer then sets a period for conducting the search (104). Next, the system matches the criteria provided by the customer with repair person information (step 106). In an alternate embodiment, the customer is provided with a list of repair persons or providers meeting the criteria that are ranked based on the search factors. In a further alternate embodiment, after the match is made, the customer may be able to obtain additional information on the repair person such as results of a background check, credit check etc. This service may be provided for a premium fee. Following the match, both the customer and the repair person matched is notified of the match (step 108). This notification could be done in a number of ways including, voice or text messaging, electronic mail, instantaneous on-screen notification, etc. After the repair person has been notified, the customer then schedules the project with the repair person (step 110). Alternatively, the system owner or administrator could coordinate scheduling by obtaining the availability of the customer and the repair person(s) and confirming the appointment. The customers are later queried by the system after the project is complete to provide feedback and ratings on the site, the repair person(s) and the scheduled project. Still further, the repair persons may be rewarded by the site based on the number of times they have provided service to site users or on the feedback and ratings they receive from customers. The site owner may also reward and rate the repair person based on availability, promptness in scheduling and other factors. The site owner or administrator may also negotiate group or individual discounts for repair persons that offer services on the site. These discounts may be passed on to end users, where the repair persons show the end users via a quote or upon final billing to show how much they saved because of the discount or where the site owner or administrator communicates the same savings via email, telephone or the mail. Additionally, users may be rewarded for the number of times and frequency of their use of the system service and other factors such as referring the site to other users, referring additional repair persons to the site, and participating in events or promotions sponsored by the site. Further still, the rewards system may be a manual or automated cash rebate system, discount system, or points-based system where the points can be used like cash to purchase awards, get discounts on services or parts and materials on the system site or at any merchant locations and websites. Rewards and available awards to repair persons or users can also be provided by service partners (like Home Depot or Lowes) based on purchases made at the service partner. It is also contemplated that the system and methods of the present invention allow for an integrated approach regarding access to the repair person and services (services herein should also be construed to include goods) offered by the site. For example, users may access the same or similar information regarding repair persons and services online on the site, over the telephone, via a local database that may be supplied via download to the user or some other storage medium, or on site at a location owned or operated by the site administrator or owner.

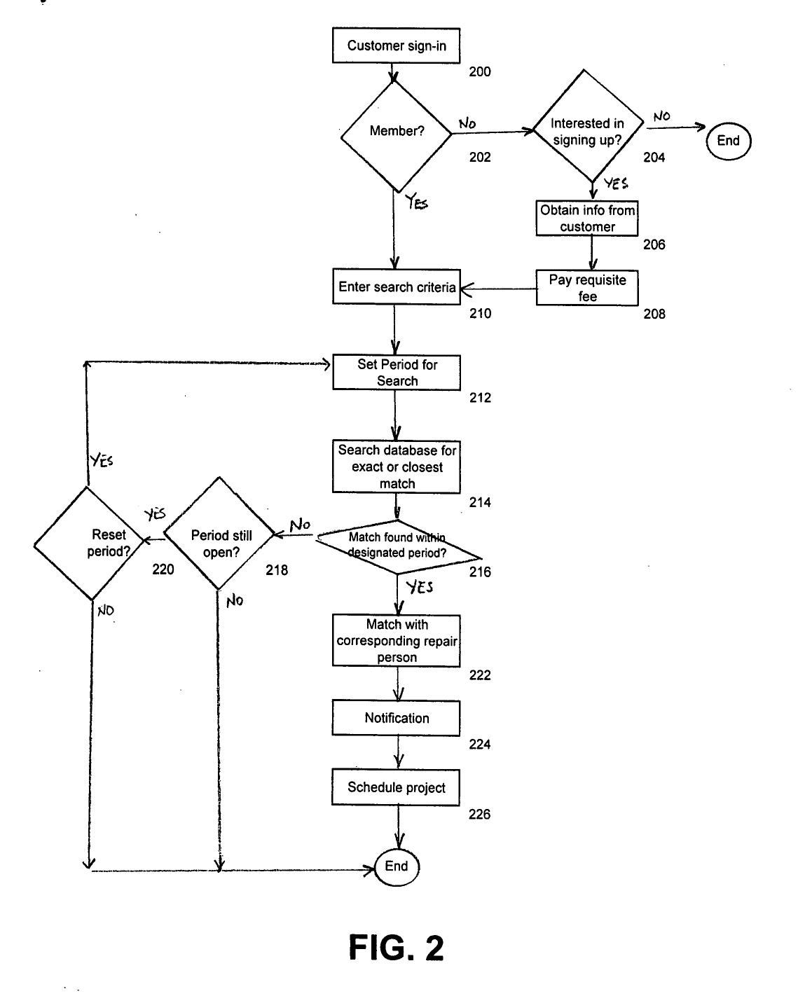

FIG. 2 shows a flow chart in accordance with the invention. After the customer signs in (step 200), the customer is queried about his or her membership status (step 202). If the customer is a current member, he/she is granted access to the system (step 210) and proceeds to the subsequent steps shown. If the customer is not a current member of the service, the system proceeds with step 204 where the customer is asked if he/she is interested in the service. If the customer is not interested the process ends. If, however, the customer wants to sign up, the system obtains his or her information in step 206 and requests the payment of the requisite fee from the customer (step 208). Next, the system allows the customer to search the database based on certain criteria (step 210). The customer, in providing the search criteria may do so by filling out a form identifying the price the customer is willing to pay for the project. In an alternate embodiment, the customer may even put in a price range he/she is willing to pay for the project. For instance, the customer may set a range of $9,000-$11,000. In such an instance, the system will provide a match or matches closest to the customer's price range. The customer during the process of providing the search criteria may also provide his/her payment means e.g. cash, credit card, check etc. After providing the search criteria, the customer then sets a period for the criteria to be matched (step 212). The system then conducts a search based on the criteria provided by the customer. Once an exact match or the closest match(es) is/are found, the customer is matched with the repair person(s) (step 222) and then must determine which repair person to select if there are multiple matches. This match, i.e. the one selected by the customer (if multiple search results) or the one provided by the system, constitutes a valid contract which the customer must accept. Both customer and repair person are then notified of the match (step 224) and either the customer, the system or the repair person schedules the project (step 226). Alternatively, the system or administrator could coordinate scheduling by obtaining the availability of the customer and repair persons and confirming the appointment. In a further alternative embodiment, after the match is made, the customer may be able to obtain additional information on the repair person such as results of a background check, credit check, or any other information the customer deems pertinent.

If, however, after the search there is no close match as dictated by the customer's range of prices, the system checks to see if the search period for conducting the search and for providing a match is still open (step 218). If the period is no longer open, the system then prompts the customer to see if he/she would like to reset the search/match period (step 220). If not, the process ends. The customer may reset the search/match period and the process reverts to step 212 and thereon.

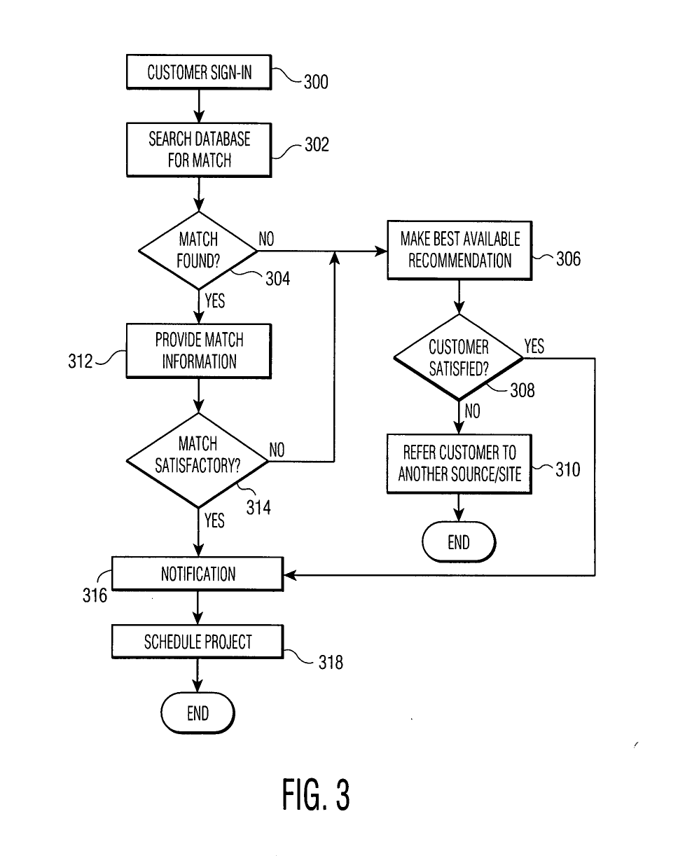

FIG. 3 shows another flow chart in accordance with the invention. After the customer signs on (step 300), he/she then searches the system by providing certain search criteria (step 302). These criteria may include services desired, cost, experience level, bonding levels etc. Once the information for the search is provided, the user then provides a period for searching and also a set prices or price range for the project. The database is then searched for an appropriate match and the system determines whether a match has been made (step 308). If not, the system then makes the best available recommendation based upon the information available on the database (step 310). The customer will then have a choice to either accept the recommendation or refuse it (step 312). If he/she accepts the recommendation, the process moves on to step 320 where the repair person (best available recommendation) is notified. If the user/customer refuses the recommendation, the system provides him/her with another site or source for information (step 314) based on what is in the site databases, by linking to other sites or “screen-scraping” information from other sites. Referring back to step 306, if a match is made, the match information is provided (step 316). The customer then has the option of deciding whether the match is satisfactory or not (step 318). If not, the system follows the path to step 310 which path is discussed above. If the customer finds the match to be satisfactory, the matched repair person is notified (step 320) and the customer schedules the project (step 322). In an alternate embodiment, after the match is made, the customer may be able to obtain additional information on the repair person such as results of a background check, credit check, or any other information the customer deems pertinent. The customer may, depending on the results of such check(s), decline the match and proceed with the next best available recommendation.

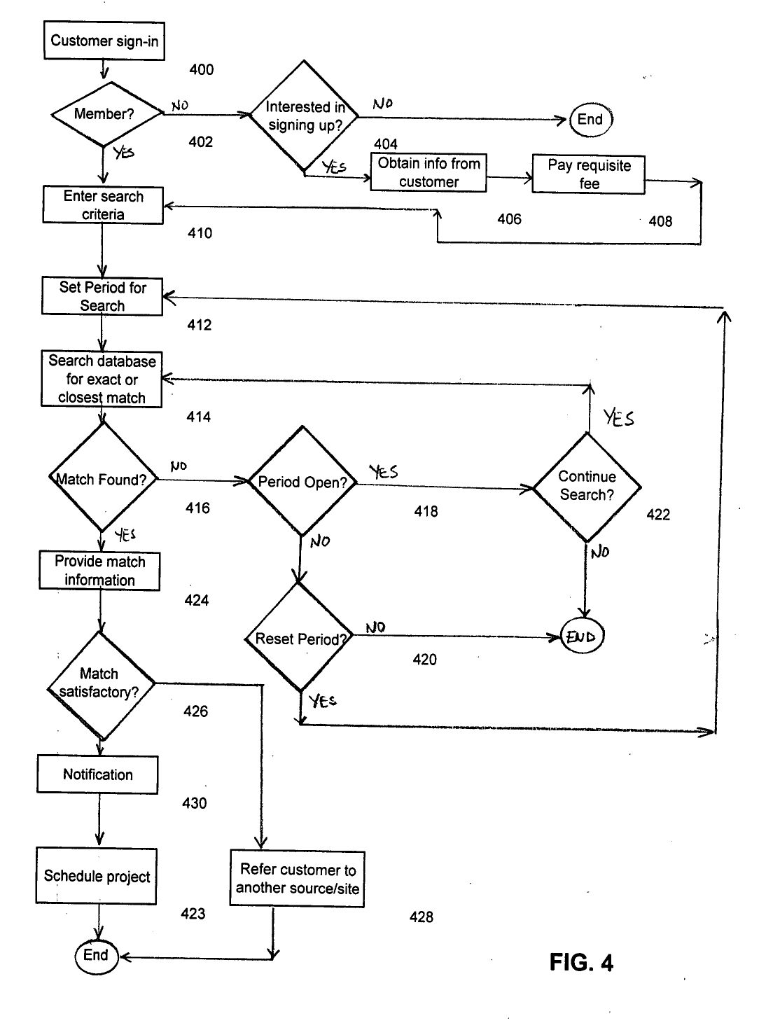

FIG. 4 shows another flow chart in accordance with the invention. After the customer signs in (step 400) he/she is queried about his/her membership status (step 402). If the customer is a current member, he/she is granted access to the system (step 410) and proceeds to the subsequent steps shown. If the customer is not a member of the service, an offer is made to sign him/her up for the service (step 404). Once the customer declines the offer, the process ends. If, however, the customer decides to sign up, the system then obtains information from the customer (step 406) and requests payment of the requisite fee (step 408). The customer is then allowed to enter search criteria (step 410) and search period (step 412). The search criteria may include the customer's set price or price range he/she is willing to pay for the project. The customer may also provide his/her means for payment at this time. The system then searches the database (step 414) and determines whether a match can be made or found (step 416). If a match is made, the system provides the customer with the match information (step 424) after which the customer decides whether the match is satisfactory (step 426). If the customer decides that the match is not satisfactory, the system then refers the customer to another site, source or partner for the customer to derive information from (step 428) thereby ending the process. If, however, the customer is satisfied with the match, both the repair person and the customer are notified and the customer then schedules the project (step 426). In an alternate embodiment, after the match is made, the customer may be able to obtain additional information on the repair person such as results of a background check, credit check, or any other information the customer deems pertinent. The customer may, depending on the results of such check(s), decline the match. Referring back to step 416, if a match is not found or made, the system checks to see if the search period is still open (step 418). If the period is no longer open, the customer or user is prompted to reset the period (step 420). When the customer/user opts to reset the period, the process reverts to step 412 and proceed from there. If, however, the period is still open, the customer/user is queried as to whether to continue the search (step 422). If the customer/user decides to continue the search, the process proceeds to step 414 and the subsequent steps. If the customer/user decides not to continue the search, the process ends.

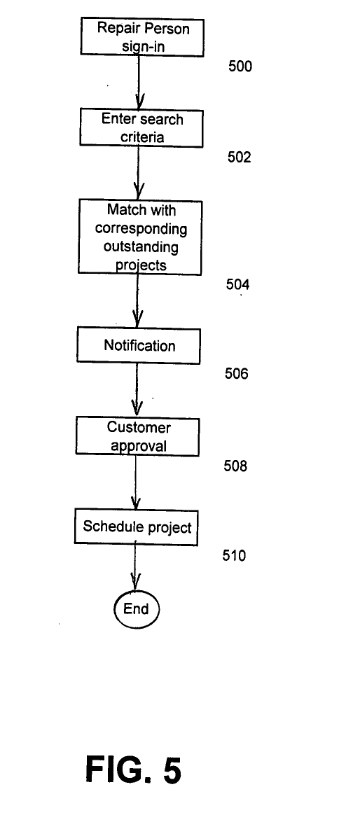

FIG. 5 is a flow chart showing a repair person's interaction with the system in accordance with the invention. The repair person signs on to the system (step 500) and enters his/her search criteria (step 502). The repair person's search criteria may be based upon a customer's budget for a given project, type of work to be done, etc. In an alternate embodiment, the customer provides the price he/she is willing to pay for the project at this step. Following the repair person's input of his/her search criteria, the system matches the criteria with any available project that comports with the search criteria (step 504). The customer is then notified about the match (step 506) either by the system or directly by the matched repair person. The customer then indicates his/her approval of the match (step 508) and the repair person then schedules the project with the customer (step 510).

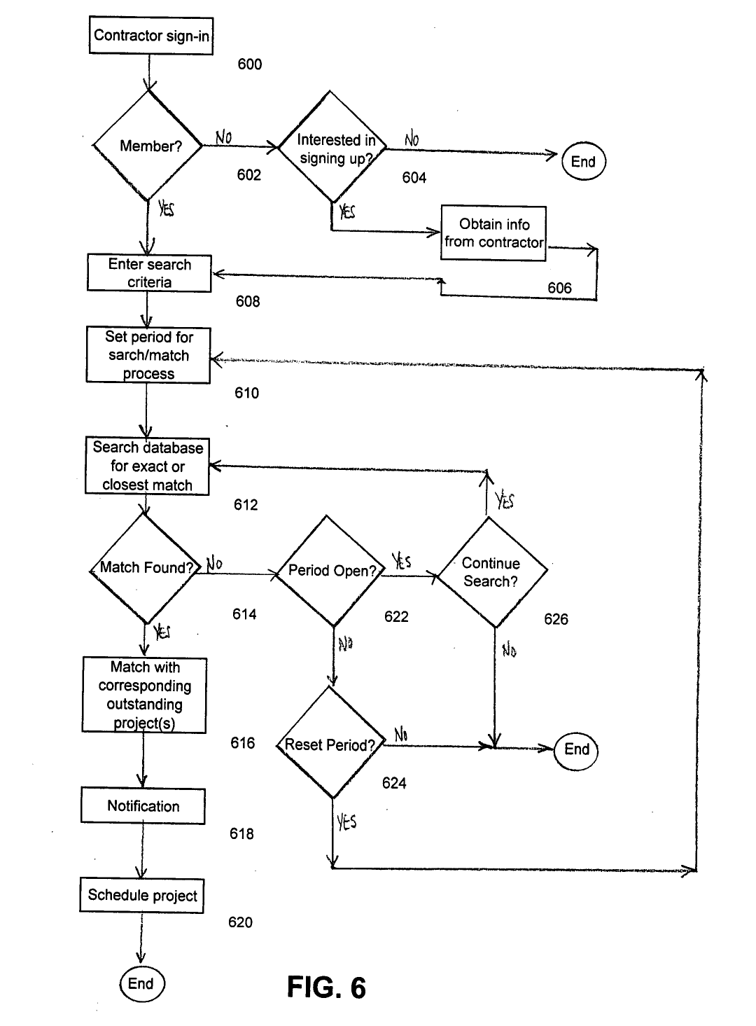

FIG. 6 shows a flow chart with another embodiment of the invention. A repair person signs on to the system (step 600) and is queried by the system about his/her membership (step 602). If the repair person is a current member, he/she is granted access to the system (step 608) and proceeds to the subsequent steps shown. If the repair person is not yet a member of the system or if his/her membership or subscription has expired, he/she is given the option to join or renew (step 604). If the repair person is interested in joining, he/she then provides information which may include his/her years of experience, bonding levels, area of expertise, industry affiliations, certifications, licenses etc. (step 606). The repair person is then granted access to the system and is allowed to search the system by entering certain search criteria (step 608). The repair person's search criteria may be based on a number of factors such as project type, time factors (scheduling availability), customers' budgets, etc. Once the repair person's criteria are entered, he/she determines and provides the time period for the search (step 610). The system then searches for a match with customer projects meeting the repair person's criteria (step 612). If a match is made (step 614), the customer and the repair person are both matched (step 616) and notified (step 618). The repair person then schedules the project (step 620). If a match is not made, the system checks to see if the search period is still open (step 622) and if a search should be continued (step 626) if the period is open. The process then proceeds to the search step (step 612). If the repair person determines that the search should continue, the system then queries the repair person as to whether to reset the search period (step 624). If the repair person resets the period (step 610), the process proceeds from there. If not, the process ends.

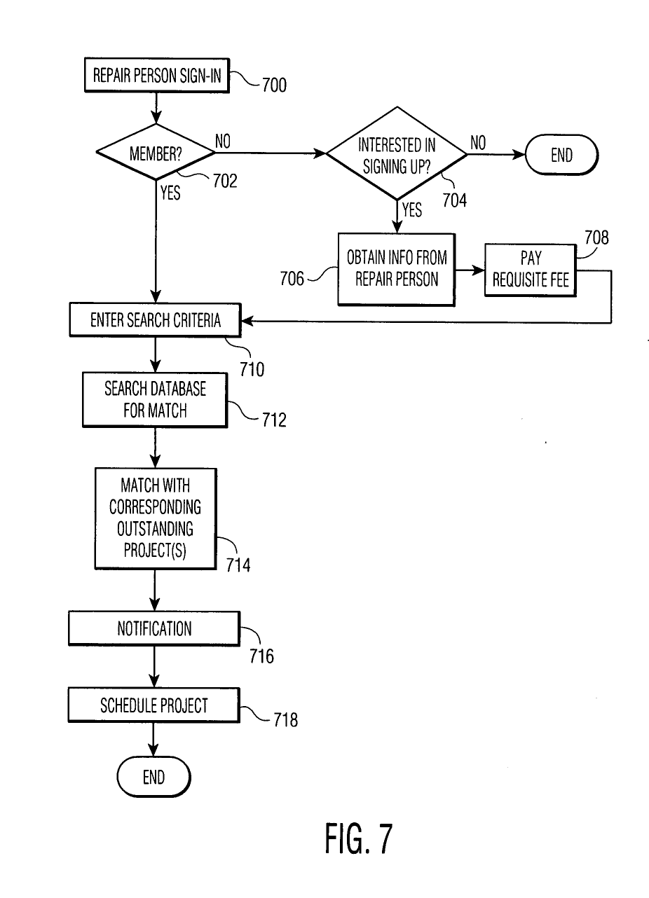

FIG. 7 shows a flow chart with another embodiment in accordance with the invention. The repair person signs on to the system (step 700) and is queried by the system about his/her membership (step 702). If the repair person is a current member, he/she is granted access to the system (step 710) and proceeds to the subsequent steps shown. If the repair person is not yet a member of the system or if his/her membership or subscription has expired, he/she is given the option to join or renew (step 704). If the repair person is interested in joining, he/she then provides information which may include his/her years of experience, bonding levels, area of expertise, industry affiliations, certifications, licenses etc. (step 706). The repair person is then required to pay a requisite fee in order to have access to the system (step 708). After the repair person has paid the fee, he/she is granted access to the system and is allowed to search the system by entering certain search criteria (step 710). The repair person's search criteria may be based on a number of factors such as project type, time factors (scheduling availability), customers' budgets, etc. Once the repair person's criteria are entered, the system then searches for a match with customer projects meeting the repair person's criteria (step 712). If a match is made (step 714), the customer and the repair person are both notified (step 716). The repair person then schedules the project (step 718).

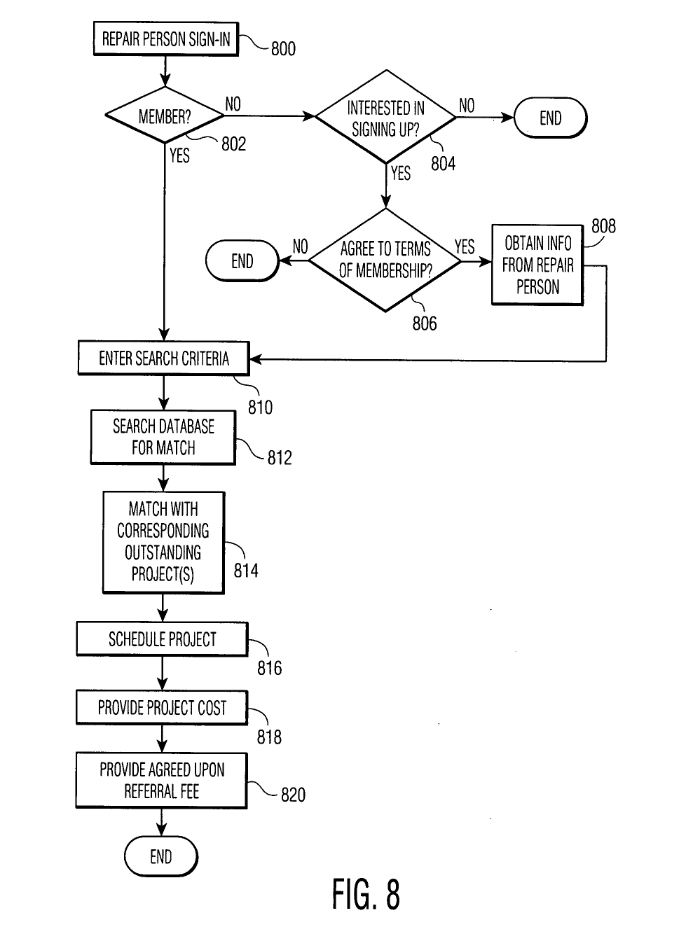

FIG. 8 shows a flow chart with another embodiment in accordance with the invention. A repair person signs on to the system (step 800) and is queried about their membership status (step 802). If the repair person is a current member, he/she is granted access to the system (step 810) and proceeds to the subsequent steps shown. If not, the system then presents him/her with the option to join or renew their membership (step 804). If the repair person is not interested, the process ends. If the repair person is interested, the system then presents the terms of membership to the repair person for approval and assent (step 806). If the repair person agrees to the terms, the system then requests and obtains information from the repair person. If the repair person does not agree to the terms of membership, the process ends. Once the system has obtained all relevant information from the repair person, the repair person is granted access to search the system for a match (steps 810 & 812). The system then searches for a match with posted projects and matches the repair person with at least one (step 814). The repair person then schedules the project (step 816). Either before or after the project has been completed, the repair person provides the overall cost for the project (step 818) and pays the agreed upon referral fee to the service (step 820).

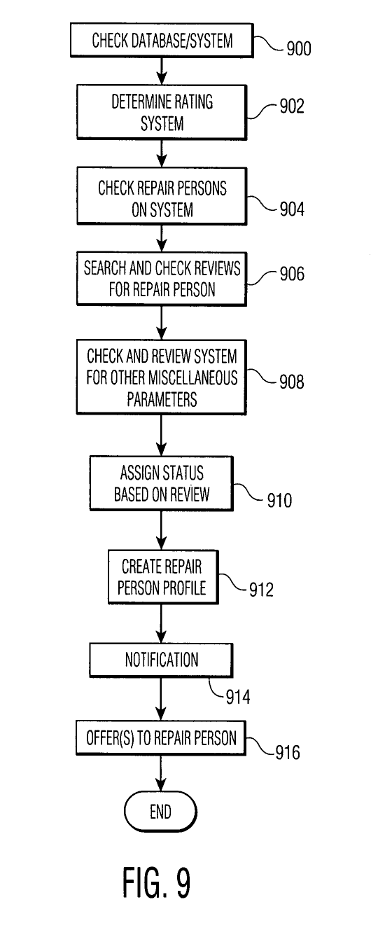

FIG. 9 shows a flow chart in accordance with the invention. The system's administrator or service partners (e.g. Home Depot)—the administrator and service partner may be the same entity in some cases—log on and check the system (step 900). The administrator then determines a rating system (step 902). Next, the administrator checks each repair person on the system by searching through reviews or other miscellaneous information on each repair person (steps 904-908). Based on the data collected and the rating system used, the administrator assigns a status to the repair person and then creates a profile based on the repair person's information and assigned status (steps 910 and 912). For example, the site may provide status levels such as “elite”, “very good”, “good”, “expensive”, “moderately priced”, “cheap” and “very cheap.” Status levels may be based on the information collected from repair persons (e.g. level of experience, records on timely delivered projects, positive or negative reviews by homeowners, etc.) and customers (reviews on repair persons, levels of satisfaction, etc.) The administrator may be a computer operated program that routinely and automatically assigns the status levels or it could be an individual authorized to conduct the tasks above. Where the administrator is a computer-operated system, the factors that determine status level are predetermined and the program assigns status levels based on the predetermined convention.

Although this invention has been disclosed with reference to specific forms and embodiments, it will be evident that a great number of variations may be made without departing from the spirit and scope of the invention. These and other changes and modifications which are obvious to those skilled in the art are intended to be included within the scope of the present invention. For example, parts or steps may be reversed, equivalent elements may be substituted for those specifically disclosed, and certain features of the invention may be used independently of other features all without departing from the invention as defined in the appended claims.

What is claimed is:

1. A method of selecting repair persons for a project, in a system by a user, comprising the steps of:
a. forming a collective of repair persons;
b. signing on to the system;
c. providing search criteria;
d. providing a set period for conducting a search;
e. searching a database of repair persons and users;
f. matching the criteria with information on at least one repair person contained in the system;
g. notifying at least one repair person; and
h. scheduling the project with said at least one repair person.

2. The method as disclosed in claim 1, wherein the step of providing search criteria further comprises the step of providing a user's set price for the project.

3. The method as disclosed in claim 1, wherein the step of providing search criteria further comprises the step of providing a user's price range for the project.

4. The method as disclosed in claim 1 further comprising the step of providing the user with information on at least one pair person meeting the user's criteria.

5. The method as disclosed in claim 1 further comprising the steps of:
a. determining whether at least an exact or close match has been made;
b. determining whether the search period is still open;
c. offering the user the at least an exact or close match;
d. providing match information where at least an exact or close match;
e. determining whether the customer is satisfied with the at least an exact or close match; and
f. referring the customer to at least one other system.

6. The method as disclosed in claim 6 further comprising the step of resetting the search period.

7. A system for selecting desired repair persons, comprising:
a. a memory device; and
b. a processor disposed in communication with the memory device, the processor configured to:
i. form a collective of repair persons;
ii. enable at least one user sign on to the system;
iii. enable at least one user to provide search criteria;
iv. enable at least one user to provide a set period for conducting a search;
v. search a database of repair persons and users;
vi. match the criteria with information on at least one repair person contained on the system;
vii. notify at least one repair person; and
viii. enable the scheduling of the project.

8. A system as disclosed in claim 7, wherein the processor is further configured to enable a user to provide a set price for the project.

9. A system as disclosed in claim 7 wherein the processor is further configured to enable a user to provide a price range for the project.

10. A system as disclosed in claim 7 wherein the processor is further configured to provide the user with information on at least one repair person meeting the user's criteria.

11. A system as disclosed in claim 7 wherein the processor is further configured to:
a. determine whether at least an exact or close match has been made;
b. determine whether the search period is still open;
c. offer the user the at least an exact or close match;
d. provide match information where at least an exact or close match;
e. determine whether the customer is satisfied with the at least an exact or close match; and
f. refer the customer to at least one other system.

12. A system as disclosed in claim 11 wherein the processor is further configured to enable a user to reset the search period.

13. A computer readable medium comprising:
a. instruction code for forming a collective of repair persons;
b. instruction code for signing on to the system;
c. instruction code for providing search criteria;
d. instruction code for providing a set period for conducting a search;
e. instruction code for searching a database of repair persons and users;
f. instruction code for matching the criteria with information on at least one instruction code for repair person contained in the system;
g. instruction code for notifying at least one repair person; and
h. instruction code for scheduling the project with said at least one repair person.

14. A computer readable medium as disclosed in claim 13 further comprising instruction code for receiving a set price.

15. A computer readable medium as disclosed in claim 13 further comprising instruction code for receiving a price range.

16. A computer readable medium as disclosed in claim 13 further comprising instruction code for providing information on at least one repair person meeting the search criteria.

17. A computer readable medium as disclosed in claim 13 further comprising:
a. instruction code for determining whether at least an exact or close match has been made;
b. instruction code for determining whether the search period is still open;
c. instruction code for offering the user the at least an exact or close match;
d. instruction code for providing match information where at least an exact or close match;
e. instruction code for determining whether the customer is satisfied with the at least an exact or close match; and
f. instruction code for referring the customer to at least one other system.

18. A computer readable medium as disclosed in claim 14 further comprising instruction code for resetting the search period.
